(19) United States
(12) Patent Application Publication
(10) Pub. No.: US 2009/0004511 A1
(43) Pub. Date: Jan. 1, 2009

(54) Battery Watering System

(76) Inventor: Mark J. Hlavac, New Lenox, IL (US)

Correspondence Address: RAMAN N. DEWAN;JACKSON WALKER, L.L.P., 100 CONGRESS AVENUE, SUITE 1100, AUSTIN, TX, 78701, US

(21) Appl. No.: 11/768,821

(22) Filed: Jun. 26, 2007

(51) Int. Cl. H01M 6/50; H01M 2/36

(52) U.S. Cl. 429/3; 429/53; 429/64; 429/79

(57) ABSTRACT

A system for adding fluid to a valve regulated lead acid (“VRLA”) battery cell includes an injection head assembly coupled to a vent opening. The injection head assembly replenishes water or electrolyte depleted during operation of the VRLA cell. Fluid is dispersed evenly across one or more absorbent gas mats to promote even absorption by the mats. Fluid may be dispersed while the VRLA is in operation, and fluid dispersion may be accomplished using continuous streams or pulsed streams.

### BACKGROUND

1. Field of the Disclosure

This disclosure relates to battery maintenance, and more specifically, to adding fluid to a VRLA (Valve Regulated Lead Acid) battery.

2. Description of the Related Art

Telecommunications networks and other electrical systems depend on uninterruptible power supplies that use backup batteries. Backup batteries require maintenance to ensure reliability. Although VRLA batteries are sometimes considered to be “no maintenance” or “low maintenance” batteries, they still require maintenance for peak performance. For example, the cells of a VRLA battery may lose water during operation, which may adversely affect the battery's energy storage capacity and internal impedance.

### BRIEF DESCRIPTION OF THE DRAWINGS

FIG. 1 depicts an embodied battery watering system for automatically adding fluid to a VRLA cell;

FIG. 2 illustrates aspects of an embodied battery watering system including details internal to a cell enclosure; and

FIG. 3. depicts an embodied battery watering system including banks of batteries, with each battery in a bank having a vent opening on a side wall, with each vent opening coupled to a fluid injector assembly for distributing fluid within the battery.

### DESCRIPTION OF THE EMBODIMENT(S)

In one aspect, a battery watering system is disclosed for introducing fluid into a VRLA battery cell (also referred to herein as a VLRA cell). The system introduces fluid into the VRLA cell during the VRLA cell's operation. The system may provide for retrofitting liquid injection heads through existing vent holes of VRLA cells. An embodied system includes a liquid feed tube that carries a quantity of fluid to within a battery enclosure. The system further includes a dispersion pump that pumps the quantity of fluid into the liquid feed tube from a reservoir. The reservoir is positioned external to the battery enclosure. The system includes a gas evacuation tube and an injection head. The injection head is for distributing the quantity of fluid substantially evenly over an absorbent glass mat (AGM).

In another aspect, a VRLA battery is disclosed. The battery has an enclosure, an absorbent glass mat, and an injection head. The injection head is for dispersing a fluid and is positioned in a head space within the enclosure. The injection head includes a plurality of openings to effectuate substantially even distribution of the fluid within the head space. The VRLA battery further includes an interface connected between the injection head and a liquid feed tube. The liquid feed tube is for supplying the fluid. The VRLA battery further includes a back pressure relief valve for preventing excess pressure within the enclosure.

In still another aspect, a battery maintenance system is disclosed. The system includes a positive terminal coupled to one or more positive plates. The battery maintenance system includes a negative terminal coupled to one or more negative plates. Further, the system includes a cell enclosure, which includes a cell lid and a cell body. The cell lid and the cell body are coupled at a seal. The cell enclosure is substantially filled with an electrolyte. The system includes a fluid inlet for receiving a fluid and includes one or more glass mat separators. The glass mat separators are positioned between the one or more positive plates and corresponding of the one or more negative plates. The system further includes one or more injection heads for inserting through an opening. The opening is formed in the enclosure lid. The injection head is for distributing the fluid substantially evenly across the one or more gas mat separators.

VRLA cells, or “batteries” of cells, may be used for uninterruptible power supply systems, security systems, emergency lighting systems, radio communications systems, engine starting, wheelchairs, golf carts, and the like. VRLA technology is distinguishable from a flooded battery design and generally has more energy density than flooded designs. Compared to VRLA technology, flooded battery technology may require a large floor space, ventilation systems, acid containment systems, and more maintenance. Central offices in telecommunications systems often use uninterruptible power supplies that may use either flooded technology, VRLA technology, or both.

There are at least two types of VRLA designs, including absorbent glass mat technology and gel battery technology. Many VRLA batteries, similar to flooded batteries, contain negative plates sandwiched between positive plates. The plates may be made of lead or a lead alloy. In addition, the plates may contain an additive of calcium or antimony, as examples. Between the positive and negative plates, separators may be positioned to provide electrical insulation.

VRLA cells are often installed in enclosures filled with an electrolyte. An electrolyte may contain sulfuric acid and water, for example. A plurality of VRLA cells may be positioned within an enclosure, making up a VRLA battery. Each VRLA cell may also have absorbed glass mats (“AGMs”) that serve as separators between positive and negative plates. In some embodiments, AGMs may be made from 100% microglass fiber, organic fibers, synthetic fibers, or other similar materials that are able to absorb and immobilize electrolyte. The AGMs are often formed from sheets of such non-conductive, microporous material, and may be wrapped around the plates. The AGM, while providing electrical separation needed to prevent shorting of the plates, permits the exchange of oxygen between the plates, thereby making the VRLA cell recombinant. Embodiments disclosed herein use controlled dispersion of fluid within a battery enclosure to help prevent the formation metallic lead. Lead is soluble in water, so residual particles including lead oxides may be present inside an enclosure. In addition, lead oxides are commonly used as active materials in many VRLA cells, for example those that use pasted plate technology. Therefore, a controlled amount of water dispersion across the glass mat surface is critical to avoid electrical short circuits and to avoid conversion of residual soluble lead oxides into metallic lead.

As its name suggests, the VRLA battery typically contains a safety vent. The safety vent can also function as a flame arrestor and may have other purposes. For example, the safety vent can prevent the release of oxygen to outside the enclosure during normal operation. The safety vent may also serve to maintain sufficient pressure within the cell enclosure for recombination to occur. In addition, the safety vent can serve to prevent sparks from entering the cell and can serve to prevent a dangerous buildup of pressure within the VRLA enclosure. Embodiments disclosed herein include injection assemblies for inserting into openings formed in a wall of a VRLA battery enclosure. In some embodiments, injector assemblies are inserted into a safety vent opening in a top wall or a side wall and provisions for venting the VRLA battery are included in the injector assembly. For example, a pressure safety valve may be incorporated into the injector assembly to provide regulation of pressure in the VRLA battery enclosure while still permitting the addition of fluids within the enclosure. In addition, some embodiments include injector assemblies that are adapted to permit the draining of excess electrolyte from a battery enclosure, permit the addition of inert shielding gases to an enclosure, and permit the installation of sensors such as pressure switches and level switches, as examples.

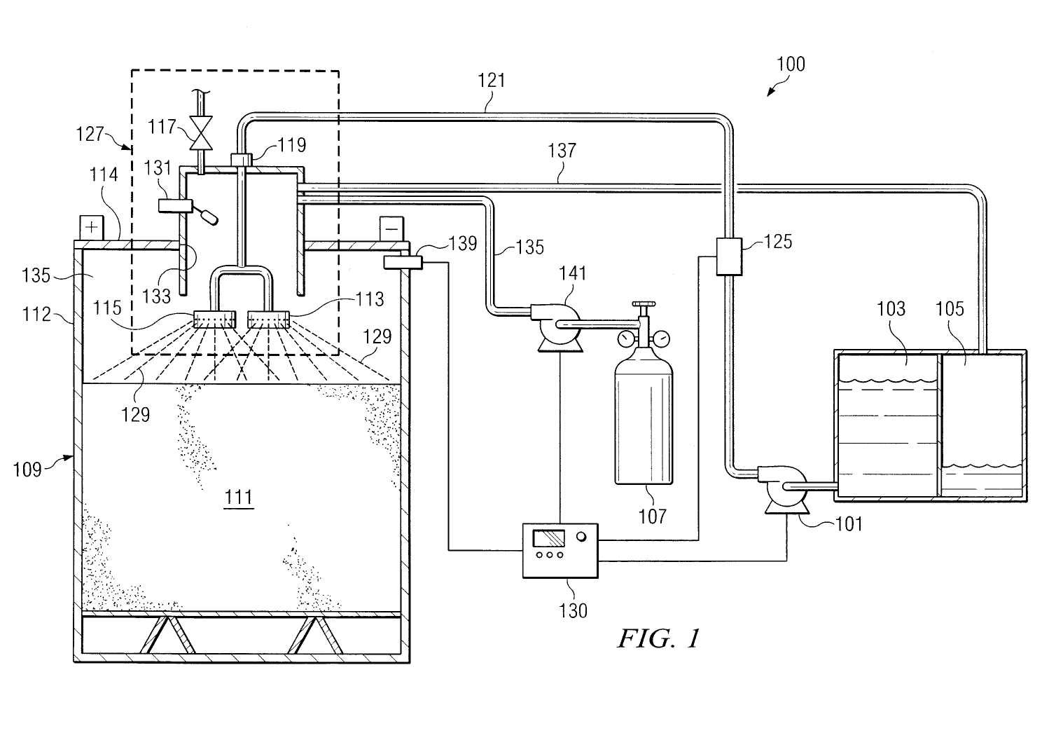

FIG. 1 illustrates an embodied watering system 100, including a cutaway view of a battery 109. As shown, battery 109 is a VRLA battery with a vent opening 133 formed into a top wall 114 of an enclosure 112. As shown, an injection assembly 127 is positioned within vent opening 133. A tight seal preferably exists between the injection assembly 127 and the vent opening 133 to prevent unwanted escape of gas or liquid from battery 109.

Injection assembly 127 is coupled to a liquid feed tube 121 that, as shown, is connected to a tube interface 119. Tube interface 119 contains packing (not shown) or is otherwise adapted to allow a tight seal with both a top wall of injection assembly 127 and feed tube 121. Injection assembly 127 also includes a first injection head 113 and, optionally, a second injection head 115 for distributing a quantity of fluid 129 within the enclosure 112. Dispersion pump 101 pumps a quantity of fluid into liquid feed tube 121, which carries the fluid into enclosure 112 through tube interface 119. Optionally, fluid flows from dispersion pump 101 through a flow meter 125, which measures the volume of fluid flowing through feed tube 121.

As shown, fluid 129 is misted or otherwise dispersed above a glass mat 111 into battery 109's head space 135. In some embodiments, head space 135 is a volume defined by four vertical walls of enclosure 112, by top wall 114 of enclosure 112, and by a top edge of one or more glass mats, such as glass mat 111. In some embodiments, enclosure 112 may contain several cells, and each cell may have its own head space, defined by tank-formed walls (not shown) that form the cell, by top wall 114 of the enclosure, and by the top edge or edges of one or more glass mats, such as glass mat 111. In the cutaway view shown in FIG. 1, only two dimensions of head space 135 are observable; however, head space 135 encompasses volume going into and out of the page.

Watering system 100 includes a liquid evacuation tube 137 coupled to injection assembly 127 to permit overflow fluid to flow from battery 109 to overflow container 105. Back pressure relief valve 117 is intended to prevent unsafe pressure buildup within battery 109. In the event of an unsafe buildup of pressure, back pressure relief valve 117 opens, allowing fluid or gas to escape enclosure 112. Back pressure relief valve 117 may be connected to a drain or container (not shown) to prevent unwanted discharge to atmosphere, in the event of a pressure event.

During operation of watering system 100, a controller 130 uses a signal from a level sensor 139 to determine whether there is a low fluid level within enclosure 112. In response to assertion of the level sensor signal, controller 130 may trigger dispersion pump 101 to pump a fluid such as water from liquid tank 103 through liquid feed tube 121 and out first injection head 113 and second injection head 115. Controller 130 optionally keeps track of the amount of fluid pumped into battery 109 using signals from flow meter 125.

In some embodiments, controller 130 keeps track of a plurality of metrics such as the date and time of any fluid transfers, overpressure events, electrolyte density, fill tank fluid temperature, electrolyte temperature, low battery levels, and any other critical battery cell operation or maintenance information. In addition, controller 130 may use glass mat absorption characteristics, which may be pre-programmed into controller 130 or otherwise derived by controller 130, to estimate an amount of fluid needed in battery 109 to obtain optimal saturation in glass mat 111, for example. Still further, controller may receive signals indicating any impurities in liquid tank 103, liquid feed tube 121, or enclosure 112. In addition to measuring and recording the above parameters, embodiments may use calibrations of cell electrolyte volume of sulfuric acid for the cell unit type to achieve optimal fluid addition. All such parameters and metrics derived or recorded by controller 130 may be used as qualifiers for liquid addition or may provide valuable maintenance information.

In some embodiments, a first injection head 113 and second injection head 115 contain holes (not shown) which are sized and angled to provide even dispersion of the fluid within head space 135 over glass mat 111. As another aspect of some embodiments, dispersion pump 101 operates to send pulses of fluid through feed tube 121. Alternatively, dispersion pump 101 provides periodic, steady flows of fluid into battery 109 as needed. Accordingly, watering system 100 promotes peak performance of battery 109 by automatically adding water to prevent “dry-out” or loss of efficiency.

As shown in FIG. 1, watering system 100 provides controller 130 with electrical control signals through data acquisition from level sensor 139, for example. In addition, a level switch 131 may optionally provide controller 130 with an indication of the fluid level within battery 109 being too high, for example. In such an event as a high level in battery 109, controller 130 would send a signal to turn off dispersion pump 101. In some embodiments, controller 130 is also operable to receive a signal from flow meter 125 regarding the accumulated fluid flow through liquid feed tube 121. In other embodiments, controller 130 optionally signals a gas injection pump 141 to pump an inert gas, for example, from cylinder 107 through a gas feed line 135 into injection assembly 127. Pumping the inert gas through the injection assembly 127 into battery 109 provides a shielding gas that tends to reduce the likelihood of an explosion from sparks that may enter head space 135. In some embodiments, controller 130 is used in conjunction with various other sensors (not shown) for monitoring the pressure within enclosure 112 or for detecting contaminants within the enclosure, as examples. Similarly, controller 130 is preferably operable to receive a signal from a level detection unit (not shown) in liquid tank 103 to trigger an alarm in the event of a low liquid level within the tank. As a further aspect of some embodiments, dispersion pump 101 may be operated while battery 109 is in service, or perhaps, on standby as part of an uninterruptible backup system. Automatically maintaining the fluid level of battery 109 while the battery is in service can be more cost effective than taking the battery out of service for maintenance.

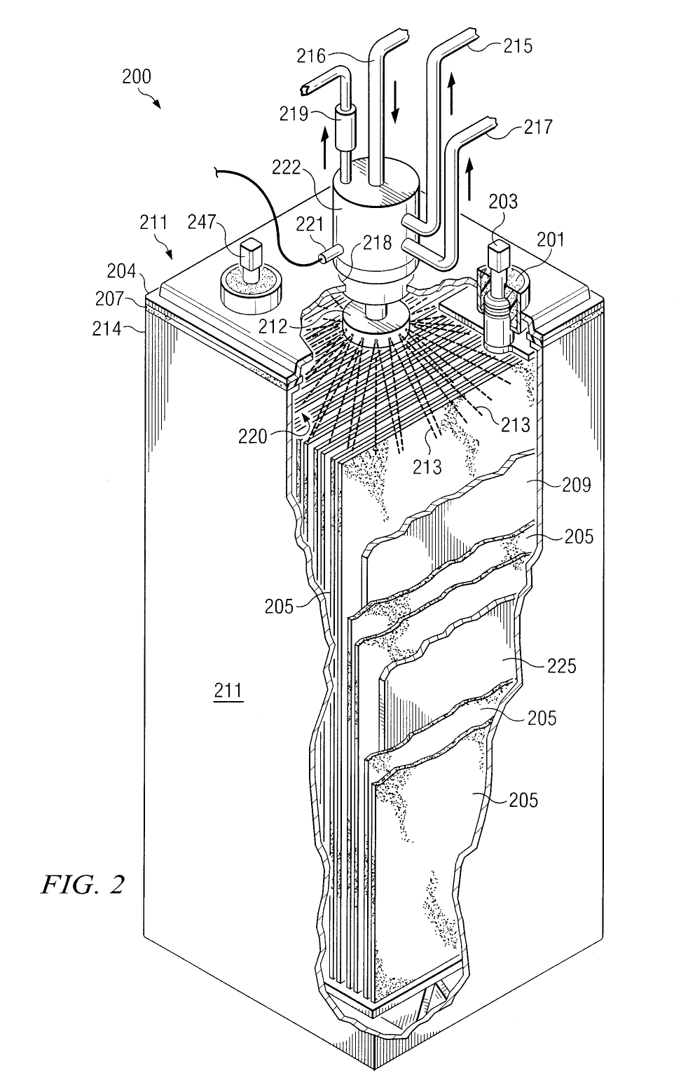

FIG. 2 depicts an embodied battery maintenance system 200 including a cell enclosure 211. Cell enclosure 211 consists of a cell lid 204 and a cell body 214. During operation, cell enclosure 211 contains an electrolyte, which may be a sulfuric acid (H2SO4) solution in water. In some embodiments, the electrolyte may be sulfuric acid mixed with water in a concentration of approximately 28% to 42% sulfuric acid. As shown, cell lid 204 and cell body 214 are coupled at a seal 207 to reduce or prevent loss of electrolyte fluid or vapor between cell lid 204 and cell body 214. Seal 207 may need to be especially leak-proof if cell enclosure 211 is turned 90 degrees from the orientation shown in FIG. 2. In other words, if cell enclosure 211 is mounted on its side, seal 207 should be leak-proof to prevent the loss of electrolyte from the enclosure. To form the seal 207, various techniques may be used. For example cell lid 204 may be bolted on using bolts with an o-ring seal, it may be glued on, it may be welded, or any other means of leak-proof connection may be used to couple cell lid 204 to cell enclosure 214.

Also coupled to cell lid 204 is an injector assembly 222, which includes a fluid inlet 216 for receiving a fluid such as water for replenishing any water that may have been lost from enclosure 211. Injector assembly 222 includes one or more injection heads 212 for inserting through an opening 218 that, as shown, is formed in the cell lid 204. The injection head 212 is for distributing the fluid 213 substantially evenly within the “head space” 220 in which injector head 212 is positioned. As shown in FIG. 2, the head space 220 is the volume defined by the four vertical walls of enclosure 214, by a plane formed by the top edges of one or more absorbent glass mats 205, and by enclosure lid 204. Distributing a fluid such as water substantially evenly into head space 220 promotes increased performance by ensuring that each of the glass mat separators 205 within enclosure 211 are exposed to the added water in even amounts.

As shown in FIG. 2, battery maintenance system 200 includes a positive terminal 203 and a negative terminal 247. Positive terminal 203 and negative terminal 247 are for connecting to an external load that requires electrical energy. In some embodiments, positive terminal 203 and negative terminal 247 may be “posts” made from copper, lead, or other conductive material. Such posts may contain tin, copper, lead, or another conductive material. Ideally, positive terminal 203 and negative terminal 247 each have a large contact area to enable the highest current-carrying capacity when coupling the cell to a load. In battery maintenance system 200, both positive terminal 203 and negative terminal 247 are sealed to prevent fluid or vapor leakage, thereby maintaining a “sealed” cell. For example, as shown, positive terminal 203 includes seal 201, which is formed from epoxy.

Within enclosure 211, positive terminal 203 is coupled to one or more positive plates, such as positive plate 209. Likewise, internal to the enclosure 211, negative terminal 247 is coupled to one or more negative plates, such as a negative plate 225. As shown, negative plate 225 and positive plate 209 are separated by one or more glass mat separators 205. In operation, glass mat separators 205 function to absorb and immobilize the electrolyte within the enclosure 211. Gas mat separators 205 preferably permit the exchange of oxygen between positive plate 209 and negative plate 225, thereby making the VRLA system within enclosure 211 recombinant, while providing electrical separation needed to prevent electrical shorting between positive plate 209 and negative plate 225.

Positive plate 209 and negative plate 225 may be made of substantially pure lead (for example 99.2% pure lead). Positive plate 209 and negative plate 225 also may be made of alloys such as lead-calcium-tin or lead-tin alloys, with tin levels ranging from approximately 0.3 to 2.0% and calcium levels ranging from approximately 0.03 to 0.09%, for example. Alternatively, alloys containing lead-antimony-cadmium and lead-strontium-tin may be used in the plates. In operation, the grids of any lead acid battery, for example positive plate 209, may be subject to a corrosion process in which lead (Pb) is transformed into lead dioxide (PbO2). This transformation of lead into lead dioxide may consume the water of the electrolyte fluid, which may reduce cell performance. Also, excessive water loss can cause premature failure of a VRLA battery by a process sometimes referred to as “dry-out.” Dry-out results in reduced electrolyte volume and capacity loss for a battery. In accordance with embodiments disclosed herein, fluid is added to a battery to help prevent dry-out and otherwise to replace fluid lost from within a cell.

During charging or operation of a cell, a current can decompose water and form hydrogen and oxygen gas. This vapor mixture can be explosive, requiring precautions to prevent over-pressure within cell enclosure 211. For example, as shown in FIG. 2, injector assembly 222 includes pressure safety valve 219. To prevent a dangerous buildup of pressure within cell enclosure 211, pressure safety valve 219 may open when the pressure within cell enclosure 211 exceeds a predetermined threshold. Upon opening, electrolyte fluid or vapor flows through pressure safety valve 219, thus allowing a decrease in pressure within cell enclosure 211.

As shown in FIG. 2, glass mat separators 205 may be made of glass fibers and serve to electrically isolate negative plate 225 and positive plate 209 from each other. Glass mat separator 205 also acts as a blotter to absorb electrolyte within the cell. Preferably, glass mat separator 205 is porous, and may be maintained in compression between the plates to assure complete contact with the plates. In some embodiments, there are many positive plates or grids and many negative plates separated by glass mat separators within an enclosure. Optionally, battery maintenance system 200 includes other features such as overflow line 217, which is for removing fluid from enclosure 211. Further, battery maintenance system 200 as shown includes gas tube 215 for vacating gas, for example, during filling the enclosure 211 with electrolyte. In addition, battery maintenance system 200 as shown includes level sensor 221, which is for sending a signal to a controller (not shown) to permit the controller to determine the fluid level within enclosure 211.

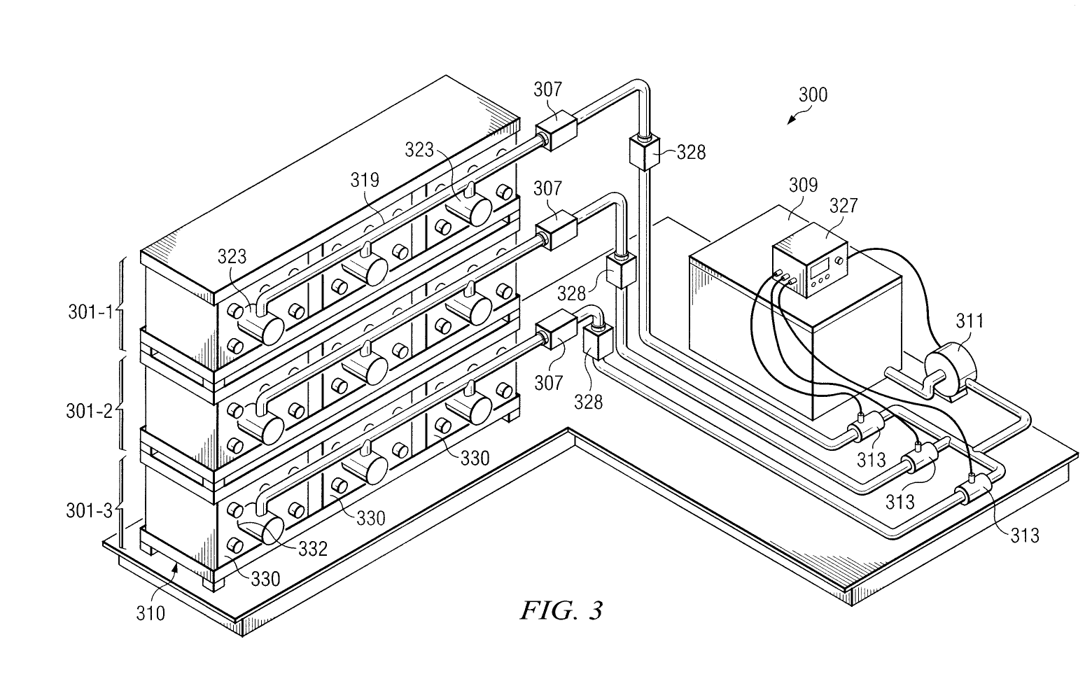

FIG. 3 illustrates an embodied system 300 for VRLA battery maintenance. System 300 includes a first battery bank 301-1, a second battery bank 301-2, and third battery bank 301-3 (generically or collectively referred to herein as battery bank(s) 301). As shown, each battery bank 301 includes three batteries 310 all positioned at the same level or elevation. Having each battery 310 in a battery bank 301 positioned at the same level facilitates synchronized filling of the batteries within a given bank 301. This is because if the batteries 310 within a battery bank 301 are connected with a tube or pipe, each battery 310 should reach the same fluid level. As shown, each battery bank 301 in system 300 includes a corresponding level switch 307. Level switch 307 for battery bank 301-1 is sensitive to a fluid level in each battery 310 in battery bank 301-1. Each level switch 307 is coupled to a controller 327 to inform controller 327 regarding the level of fluid in the corresponding battery bank 301. As illustrated, pipes 319 connect injector assemblies 323 for the batteries within a given battery bank 301. For each battery bank 301, a corresponding flow meter 328 records an amount of fluid flowing into the battery bank. Also for each battery bank 301, using signals from level switches 307, controller 327 makes a determination regarding whether any battery bank 301 needs fluid. If a battery bank 301 needs fluid, controller 327 communicates with a dispersion pump 311 and a set of solenoids 313 to achieve fluid flow within a particular battery bank 301, for example, battery bank 301-1. Dispersion pump 311 pumps fluid from fluid tank 309, through an appropriate solenoid 313, through a corresponding flow meter 328 and level switch 307, and into each battery 310 within the corresponding battery bank 301. Accordingly, system 300 controls the electrolyte level within a particular battery bank 301.

An additional aspect of system 300 is that each battery 310 within a battery bank 301 is turned on its side, when compared to the battery maintenance system 200 (FIG. 2). In other words, each battery, as positioned, has a side wall 330 with a vent opening 332 formed within the side wall. In accordance with embodiments of this disclosure, each side wall 330 has an injector assembly 323 coupled to a corresponding vent opening 332 to allow the addition of fluid within the battery. Although in FIG. 3 details regarding injection of fluid within each battery are omitted, for each battery 310, injector assembly 323 includes holes drilled at proper angles and otherwise positioned to effectuate evenly distributing fluid into each battery within the headspace over one or more glass mat separators. Such even distribution of fluid allows gas absorption mats internal to each cell of each battery to evenly absorbed the water that is injected. Such even absorption promotes maintaining peak performance from the battery.

The above disclosed subject matter is illustrative, and not restrictive, and the appended claims are intended to cover all modifications, enhancements, and other embodiments which that would occur to one of ordinary skill in the field having the benefit of this disclosure. Thus, to the maximum extent allowed by law, the scope of the present invention is to be determined by the broadest permissible interpretation of the following claims and their equivalents, and shall not be restricted or limited by the foregoing detailed description.

What is claimed is:

1. A battery watering system comprising:
a feed tube for moving a quantity of fluid to within a battery enclosure;
a dispersion pump for pumping the quantity of fluid through the feed tube from a reservoir external to the battery enclosure;
a gas evacuation tube for evacuating a gas from the battery enclosure; and
an injection head for distributing the quantity of fluid substantially evenly over an absorbent glass mat (AGM), the injection head positioned within the battery enclosure through the vent opening; and
a controller for triggering the dispersion pump responsive to a signal indicative of a fluid level within the battery enclosure.

2. The battery watering system of claim 1, wherein the injection head defines a plurality of substantially evenly-spaced holes for effecting substantially even fluid dispersion above a plurality of AGMs, the AGMs installed in a valve regulated lead acid battery.

3. The battery watering system of claim 2, the battery watering system further comprising:
an injection pump for pumping a shielding gas into the battery enclosure.

4. The battery watering system of claim 3 further comprising:
a back pressure relief valve to prevent excess pressure within the battery enclosure.

5. The battery watering system of claim 4, further comprising:
a fluid evacuation tube for evacuating a fluid from the battery enclosure.

6. The battery watering system of claim 5, wherein the battery watering system is operable to move the quantity of fluid within the battery enclosure while the battery is operating and connected to a load.

7. The battery watering system of claim 1, wherein the dispersion pump drives the quantity of fluid into the liquid feed tube using a pulse technique, the pulse technique consisting of alternating periods of driving the fluid into the liquid feed tube and periods of not driving the fluid into the liquid feed tube.

8. The battery watering system of claim 6, the battery watering system further comprising:
a monitoring system for measuring and recording a plurality of metrics related to the quantity of fluid carried to within the battery enclosure.

9. The battery watering system of claim 1, further comprising a level sensor for monitoring a level of electrolyte in the battery enclosure.

10. A valve regulated lead acid (VRLA) battery, the battery comprising:
an enclosure;
an absorbent glass mat;
an injection head assembly, the injection head assembly including an injection head for dispersing a fluid, the injection head positioned within a head space within the enclosure, the injection head including a plurality of openings to effectuate substantially even distribution of the fluid within the head space;
a tube interface, the tube interface connected between the injection head and a liquid feed tube, the liquid feed tube for supplying the fluid; and
a back pressure relief valve for preventing excess pressure within the enclosure.

11. The VRLA battery of claim 10 wherein the absorbent glass mat is positioned vertically within the enclosure, wherein the plurality of injection head holes are sized and positioned to provide substantially uniform dispersion of the fluid above and along a length of the absorbent glass mat.

12. The VRLA battery of claim 11:
wherein the injection head assembly is coupled to a liquid evacuation tube, the liquid evacuation tube for removing electrolyte from the enclosure.

13. The VRLA battery of claim 12, wherein the injection head assembly is coupled to a gas evacuation tube, the gas evacuation tube for removing gas from the enclosure.

14. The VRLA battery of claim 13, wherein the dispersed fluid has a measured amount, the measured amount recorded by a controller.

15. The VRLA battery of claim 10, wherein the dispersion pump is operable to supply the fluid during operation of the VRLA battery.

16. A battery maintenance system comprising:
a positive terminal, the positive terminal coupled to a positive plate;
a negative terminal, the negative terminal coupled to a negative plate;
a cell enclosure comprising a cell lid and a cell body, the cell lid and the cell body coupled at a seal, the cell enclosure substantially filled with an electrolyte;
a fluid inlet for receiving a fluid;
a glass mat separator positioned between the positive plate and the negative plate; and
one or more injection heads positioned to disperse fluid through an opening, the opening formed in the cell lid, the injection head for distributing the fluid substantially evenly across the gas mat separator.

17. The battery maintenance system of claim 16, further comprising:
an overflow outlet, the overflow outlet for removing a first portion of the electrolyte from the enclosure.

18. The battery maintenance system of claim 17, further comprising:
a level sensor, the level sensor triggered in response to an electrolyte level within the enclosure reaching a predetermined level;
a gas outlet, the gas outlet for removing a vapor from the enclosure; and
a pressure safety valve, the pressure safety valve for removing a second portion of the electrolyte or a first portion of the vapor in response to detecting a predetermined pressure within the enclosure.

19. The battery maintenance system of claim 18, wherein the fluid is pumped during periodic pulses.

20. The battery maintenance system of claim 19, further comprising:
a controller, the controller for receiving a signal from the level sensor, the controller for triggering a dispersion pump to pump the fluid through the fluid inlet;
a solenoid for preventing and permitting flow in response to the controller.
